(19) United States
(12) Patent Application Publication
(10) Pub. No.: US 2022/0029392 A1
(43) Pub. Date: Jan. 27, 2022

(54) LINE PULLING SYSTEMS AND DEVICES

(71) Applicant: Sherman + Reilly, Inc., Chattanooga, TN (US)

(72) Inventors: Michael Dunn, Chattanooga, TN (US); Tim Hanson, Chattanooga, TN (US); Michael Mooney, Chattanooga, TN (US); John Morton, Chattanooga, TN (US)

(21) Appl. No.: 17/383,968

(22) Filed: Jul. 23, 2021

Related U.S. Application Data
(60) Provisional application No. 63/056,005, filed on Jul. 24, 2020.

(51) Int. Cl. H02G 1/08; B66D 1/16; B66D 1/08

(52) U.S. Cl. CPC H02G 1/085; B66D 1/08; B66D 1/16

(57) ABSTRACT

The disclosed technology includes a line pulling system having a chassis configured to support a line pulling drum. The line pulling drum can receive a line and a motor can be configured to rotate the line pulling drum in a first direction to cause the line to wind around the line pulling drum and in a second direction to facilitate removal of the line from the line pulling drum. The line pulling system can include a driven element, a driving element, and a coupling ring that can be configured to transition between an engaged position and a disengaged position. When in the engaged position, the coupling ring can couple the driving element to the driven element to cause a torque applied by the motor to be transferred to the line pulling drum. When in the disengaged position, the coupling ring can uncouple the driving element from the driven element.

### CROSS-REFERENCE TO RELATED APPLICATIONS

This application claims benefit under 35 USC § 119(e) of U.S. Provisional Patent Application No. 63/056,005 filed 24 Jul. 2020, the entirety of which is incorporated herein by reference as if set forth herein in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The disclosed technology relates generally to systems and devices used for pulling lines; and, more specifically, to systems and devices for pulling lines used in the electrical utility industry.

### 2. Description of Related Art

Line pulling equipment is a vital tool in the utility industry. Such equipment can be used to manipulate wires, ropes, cables, and other materials (collectively, “lines”) during installation (e.g., installing new power lines) and/or reconductoring (e.g., pulling a new conductor through an old line). In the process of manipulating lines, the line pulling equipment can provide both pulling and tensioning. In certain examples, utility lines can extend for long distances, greatly increasing the forces and stresses on the line pulling equipment.

There a several problems with existing line pulling equipment. The large forces and stresses exerted on the line pulling equipment can pose a severe risk to an operator and/or other user of the line pulling equipment. The energy stored in lines under tension suddenly being released due to a failure can cause severe injury to those in the immediate area as the line whips back toward the puller. Additionally, the forces and stresses can place an increased strain on hydraulic systems in the line pulling equipment. This can result in elevated temperatures which, in turn, can decrease the efficiency of the system and increase maintenance costs and energy consumption.

There is also a need to improve the mechanisms by which torque is transferred through line pulling equipment. Many existing methods of transmitting torque can have the ability to be coupled and uncoupled before and after use, but the current designs require many additional parts and/or specialized tools to couple and decouple. While the large amount of small coupling parts is already inconvenient (requiring several specific steps to carry out), the smaller parts can also fail or be forgotten. This increases the risk of decoupling under the intense stresses and forces which presents safety and maintenance issues.

All of the aforementioned problems increase risks when operating current line pulling equipment. The intense stresses and forces can break lines and equipment and can damage surrounding structures and injure workers. These and other problems are addressed by examples of the technology disclosed herein.

### SUMMARY

Examples of the present disclosure can include a line pulling system comprising a chassis configured to support a line pulling drum. The line pulling drum can be configured to receive a line. The line pulling system can have a motor configured to rotate the line pulling drum in a first direction to cause the line to wind around the line pulling drum and in a second direction to facilitate removal of the line from the line pulling drum. The line pulling system can further include a driven element coupled to the line pulling drum, a driving element coupled to the motor, and a coupling ring configured to transition between an engaged position and a disengaged position. When in the engaged position, the coupling ring can be configured to couple the driving element to the driven element to cause a torque applied by the motor to be transferred to the line pulling drum. When in the disengaged position, the coupling ring can be configured to uncouple the driving element from the driven element.

The driven element and the driving element can each comprise a plurality of shoulders and the coupling ring can comprise a plurality of grooves configured to receive the plurality of shoulders such that the coupling ring can be configured to slide along the driven element and the driving element between the engaged position and the disengaged position. In some examples, the driven element can comprise four shoulders, the driving element can comprise four shoulders, and the coupling ring can comprise four grooves.

The coupling ring can further comprise a cutaway portion. The cutaway portion can form a ridge that can be configured to contact the driving element when the coupling ring is in the engaged position to prevent the coupling ring from transitioning to the disengaged position. In some examples, the coupling ring can include a plurality of cutaway portions. Each cutaway portion of the plurality of cutaway portions can form a ridge that can be configured to contact the driving element when the coupling ring is in the engaged position. Each cutaway portion of the plurality of cutaway portions can be positioned proximate each groove of the plurality of grooves. The ridge can be configured to contact the driving element when a tension is applied to the driven element.

The line pulling system can further include a hydraulic system. The hydraulic system can include a manifold that can be configured to facilitate heat transfer between a first hydraulic line and a second hydraulic line. The manifold can include a heat exchanger that can be configured to facilitate heat transfer between the first hydraulic line and the second hydraulic line. The first hydraulic line can be configured to drive the line pulling drum and the second hydraulic line can be configured to drive an auxiliary component. In some examples, the first hydraulic line can be a closed loop system and the second hydraulic line can be an open loop system. In other examples, the first hydraulic line can be an open loop system and the second hydraulic line can be a closed loop system. In yet other examples, the first and second hydraulic lines can both be open loop systems or both be closed loop systems.

The line pulling system can further include an operator station. The operator station can include a safety screen positioned between the line pulling drum and the operator station, and a control panel that can be configured to communicate with at least the motor. In some examples, the safety screen can be curved to deflect objects that strike the safety screen and be a mesh with apertures having a hexagonal shape.

The control panel can include a joystick that can be configured to facilitate control of the line pulling drum and a hand rest that can be configured to support a hand of an operator of the line pulling system.

The chassis can be a trailer having a plurality of wheels and a trailer hitch. The chassis can also include a level wind that can be configured to move laterally with respect to the line pulling drum to ensure a line wound around the line pulling drum is distributed evenly.

The disclosed technology can further include a line pulling system having a chassis comprising a plurality of wheels and a hitch, an operator station mounted on the chassis and comprising a control panel and a safety screen, a line pulling drum mounted on the chassis that can be configured to receive a line, and a motor mounted on the chassis that can be configured to rotate the line pulling drum in a first direction to cause the line to wind around the line pulling drum and in a second direction to facilitate removal of the line from the line pulling drum. The line pulling system can further include a driven element coupled to the line pulling drum, a driving element coupled to the motor, and a coupling ring that can be configured to transition between an engaged position and a disengaged position. When in the engaged position, the coupling ring can be configured to couple the driving element to the driven element to cause a torque applied by the motor to be transferred to the line pulling drum, When in the disengaged position, the coupling ring can be configured to uncouple the driving element from the driven element.

The driven element and the driving element can each comprise a plurality of shoulders and the coupling ring can comprise a plurality of grooves that can be configured to receive the plurality of shoulders such that the coupling ring can be configured to slide along the driven element and the driving element between the engaged position and the disengaged position. The coupling ring can further comprise a cutaway portion. The cutaway portion can form a ridge that can be configured to contact the driving element when the coupling ring is in the engaged position to prevent the coupling ring from transitioning to the disengaged position.

### DESCRIPTION OF THE DRAWINGS

FIG. 1A is a front, perspective view of an example of a line pulling system, in accordance with some examples of the present disclosure.

FIG. 1B is a rear, perspective view of an example of a line pulling system, in accordance with some examples of the present disclosure.

FIG. 1C is a side view of an example of a line pulling system, in accordance with some examples of the present disclosure.

FIG. 1D is a front view of an example of a line pulling system, in accordance with some examples of the present disclosure.

FIG. 2 is a front, perspective view of an example of a driven element used in a line pulling system, in accordance with some examples of the present disclosure.

FIG. 3 is a front, perspective view of an example of a driving element used in a line pulling system, in accordance with some examples of the present disclosure.

FIG. 4 is a front, perspective view of an example of a coupling ring used in a line pulling system, in accordance with some examples of the present disclosure.

FIG. 5A is a cross-sectional view of a coupling ring in an uncoupled position over a driven element and driving element, in accordance with some examples of the present disclosure.

FIG. 5B is cross-sectional view of the coupling ring of FIG. 5A in a coupled position over a driven element and driving element, in accordance with some examples of the present disclosure.

FIG. 5C is cross-sectional view of the coupling ring of FIG. 5A in a coupled position and under tension over a driven element and driving element, in accordance with some examples of the present disclosure.

FIG. 6 is a cross-sectional view of a manifold used in a line pulling system, in accordance with some examples of the present disclosure.

FIG. 7 is a perspective view of an operator station and front safety screen used in a line pulling system, in accordance with some examples of the present disclosure.

FIG. 8 is a top perspective view of a control panel in an operator station used in a line pulling system, in accordance with some examples of the present disclosure.

FIG. 9 is a perspective view of a hand rest on the control panel of FIG. 8 used in a line pulling system, in accordance with some examples of the present disclosure.

### DETAILED DESCRIPTION

Examples of the present disclosure can comprise a system for pulling wires, ropes, and the like (collectively, “lines”). The system can comprise a line pulling drum including a driven element, a motor with a driving element, and a coupling ring configured to mate the driving element to the driven element. The coupling ring can be configured to securely engage the driving element and the driven element to prevent uncoupling of the driven element when the line pulling drum is under tension (e.g., during a line pulling operation). The system can also include a heat exchanger in fluid communication with a plurality of hydraulic lines providing power to the motor. The heat exchanger can help to reduce, or altogether prevent, overheating of the hydraulic system and resultant failure of the hydraulic system components. The system can also include an operator station comprising a control panel configured to communicate with the motor and a front safety screen between the operator station and the line pulling drum. As will become apparent throughout this disclosure, the systems and devices described herein can reliably couple the motor to the line pulling drum, improve the efficiency and reliability of the hydraulic system, and protect the operator during operation resulting in a safer and more efficient line pulling system when compared to existing systems.

For ease of explanation, the system is discussed below with reference to stringing and supporting power and communications lines. One of skill in the art will recognize, however, that the system is not so limited. Indeed, the system could be used in any number of industries where ropes, support cables (e.g., for ski lifts), communications cables, wires, and other similar products need to be efficiently installed and supported. Thus, the description below is intended to be illustrative and not limiting.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named. In other words, the terms “a,” “an,” and “the” do not denote a limitation of quantity, but rather denote the presence of “at least one” of the referenced item.

As used herein, the term “and/or” may mean “and,” it may mean “or,” it may mean “exclusive-or,” it may mean “one,” it may mean “some, but not all,” it may mean “neither,” and/or it may mean “both.” The term “or” is intended to mean an inclusive “or.”

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose. It is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value. Further, the term “about” means within an acceptable error range for the particular value as determined by one of ordinary skill in the art, which will depend in part on how the value is measured or determined, i.e., the limitations of the measurement system. For example, “about” can mean within an acceptable standard deviation, per the practice in the art. Alternatively, “about” can mean a range of up to ±20%, preferably up to ±10%, more preferably up to ±5%, and more preferably still up to ±1% of a given value. Alternatively, the term can mean within an order of magnitude, preferably within 2-fold, of a value. Where particular values are described in the application and claims, unless otherwise stated, the term “about” is implicit and in this context means within an acceptable error range for the particular value.

Throughout this disclosure, various aspects of the disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Throughout this description, various components may be identified having specific values or parameters, however, these items are provided as exemplary embodiments. Indeed, the exemplary embodiments do not limit the various aspects and concepts of the present disclosure as many comparable parameters, sizes, ranges, and/or values may be implemented. The terms “first,” “second,” and the like, “primary,” “secondary,” and the like, do not denote an order, quantity, or importance, but rather are used to distinguish one element from another.

It is noted that terms like “specifically,” “preferably,” “typically,” “generally,” and “often” are not utilized herein to limit the scope of the claimed disclosure or to imply that certain features are critical, essential, or even important to the structure or function of the claimed disclosure. Rather, these terms are merely intended to highlight alternative or additional features that may or may not be utilized in a particular embodiment of the present disclosure. It is also noted that terms like “substantially” and “about” are utilized herein to represent the inherent degree of uncertainty that may be attributed to any quantitative comparison, value, measurement, or other representation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “50 mm” is intended to mean “about 50 mm.”

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described hereinafter as making up the various elements of the present disclosure are intended to be illustrative and not restrictive. Many suitable materials that would perform the same or a similar function as the materials described herein are intended to be embraced within the scope of the disclosure. Such other materials not described herein can include, but are not limited to, materials that are developed after the time of the development of the disclosure, for example. Any dimensions listed in the various drawings are for illustrative purposes only and are not intended to be limiting. Other dimensions and proportions are contemplated and intended to be included within the scope of the disclosure.

The components described hereinafter as making up various elements of the disclosed technology are intended to be illustrative and not restrictive. Many suitable components that would perform the same or similar functions as the components described herein are intended to be embraced within the scope of the disclosed technology. Such other components not described herein can include, but are not limited to, similar components that are developed after development of the presently disclosed subject matter.

As mentioned previously, the stress and tension required to string heavy transmission lines, for example, can cause damage to surrounding structures, injure workers, and even damage the line when there is any type of drive failure. Any motor providing torque must be safely coupled to the line pulling drum without slipping or failing under tension. Additionally, the increased tension places a higher load on any hydraulic systems used by the line pulling equipment, raising temperatures and reducing efficiency and longevity. Workers, poles, and structures near lines under tension are at significant risk in the event of a failure of the line or the line pulling equipment.

In addition, current line pullers tend to have a main drive hydraulic system for powering the drum and auxiliary hydraulics for other functions (e.g., lowering jacks, moving winding guides, etc.). As a result, the main drive hydraulics tend to run at a higher temperature than the auxiliary hydraulics. As in most mechanical systems, these elevated temperatures can reduce efficiency and increase wear, among other things.

Unfortunately, conventional power couplers—i.e., the couplers that connect the motor to the drum—tend to include various small coupling parts and complicated steps for coupling and decoupling. Thus, as the components get used and worn, the small parts can be lost or fail, and the complicated processes for coupling and decoupling can waste valuable time. With the large forces involved in the line stringing process, it is critical to simplify the coupling/decoupling process while maintaining a guaranteed and confident engagement. Therefore, it would be useful to improve the coupling of a motor to the line pulling drum to reduce the risk of slippage and failure, as well as to simplify the coupling and decoupling process. It would also be desirable to improve the efficiency of the hydraulic system and the safety of workers in close proximity to the line pulling equipment. It is to these line pulling systems and devices that examples of the present disclosure are primarily directed.

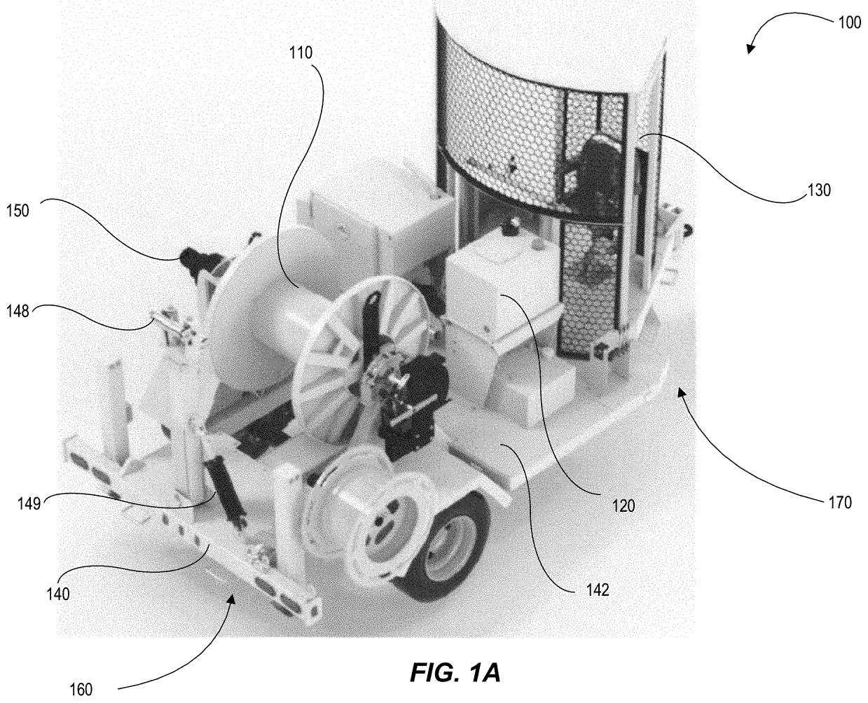

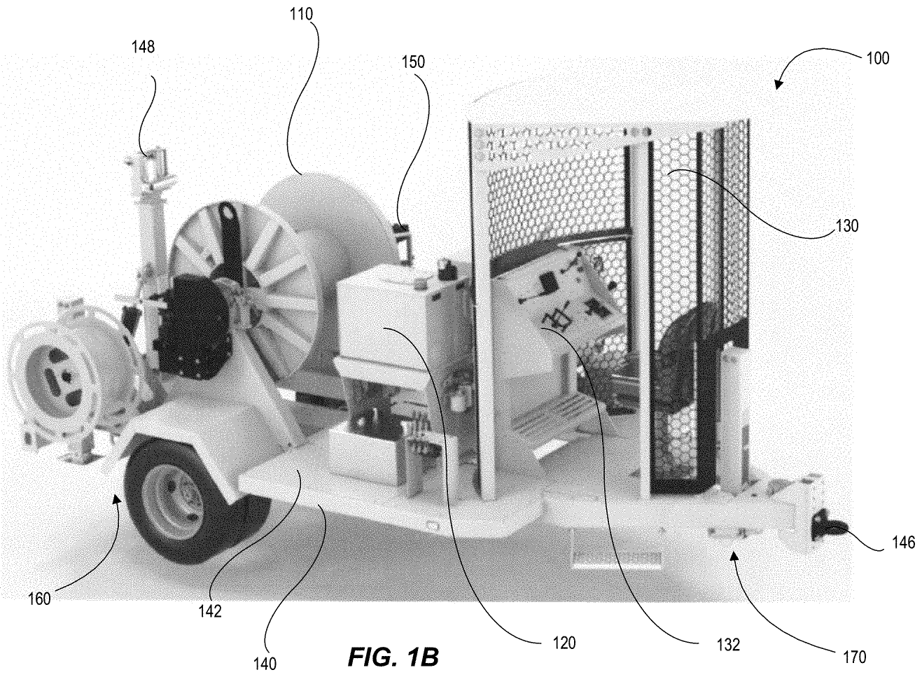

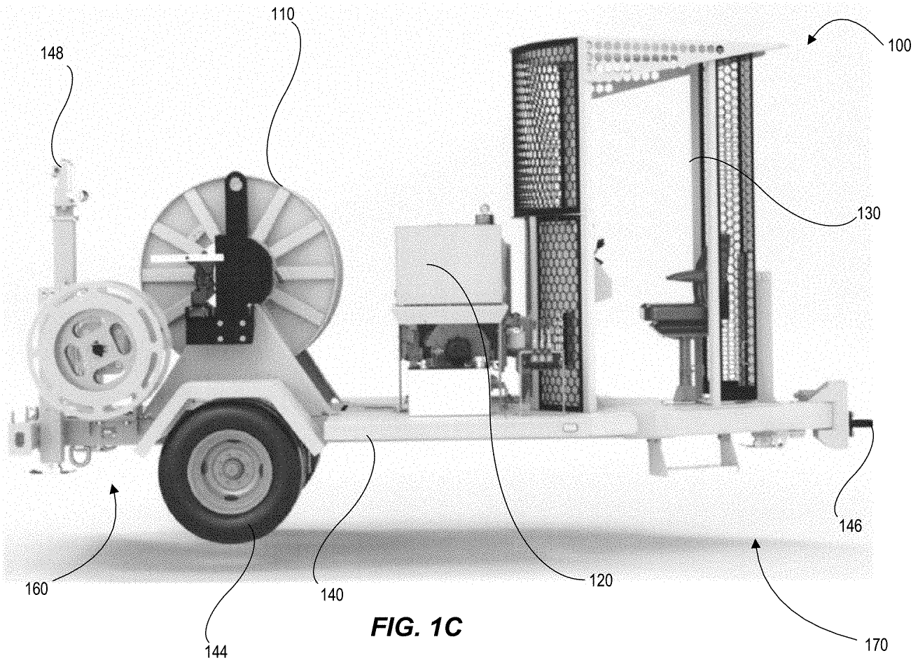

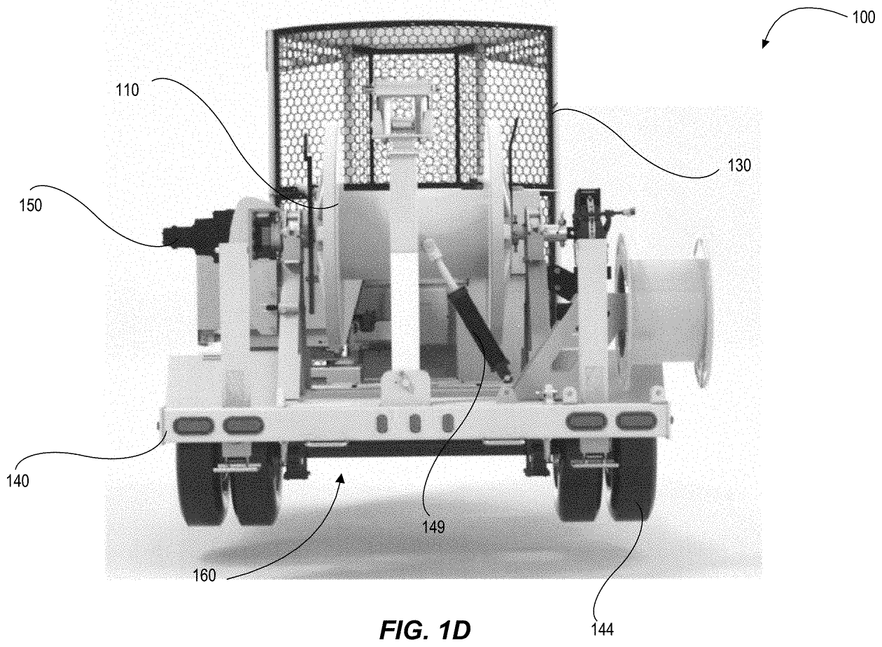

As shown in FIG. 1A-D, an improved line pulling system 100 can comprise a line pulling drum 110, a hydraulic system 120, and an operator station 130. The line pulling system 100 can further comprise a chassis 140 to support some or all of the components discussed herein, and the line pulling system 100 can also have a motor 150 to power some, or all, of the components discussed herein. In some examples, the motor 150 can be configured to cause the line pulling drum 110 to be rotated in a first direction to receive the line and in a second direction to facilitate removal of the line from the line pulling drum 110.

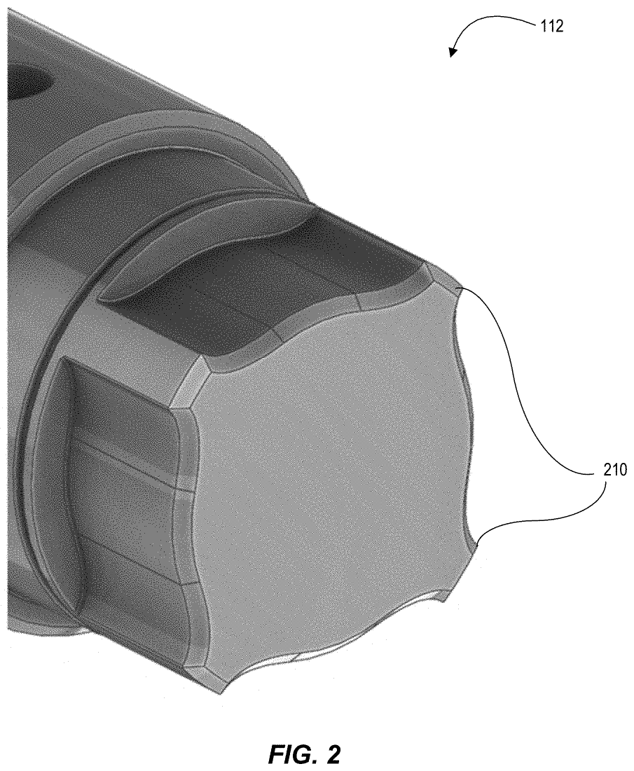

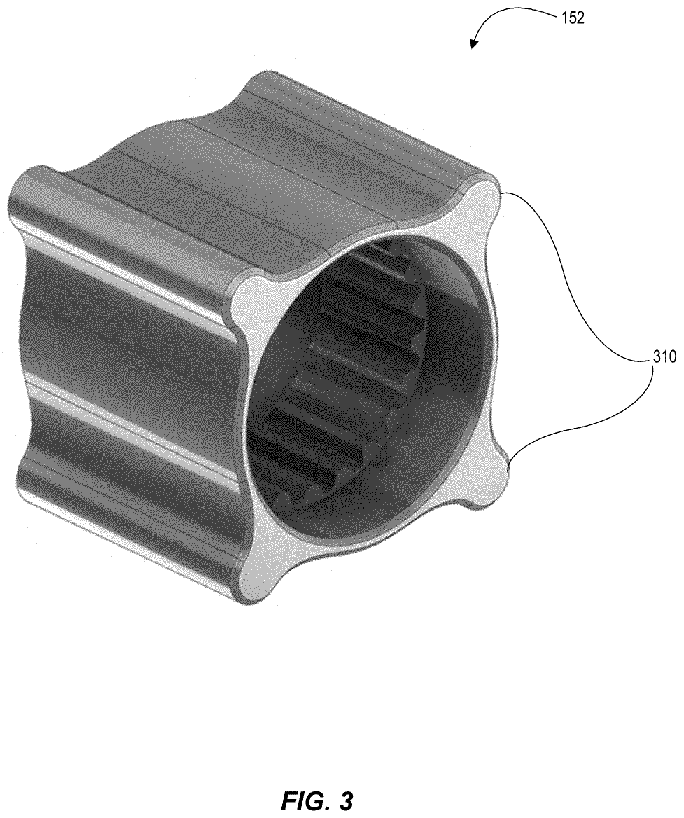

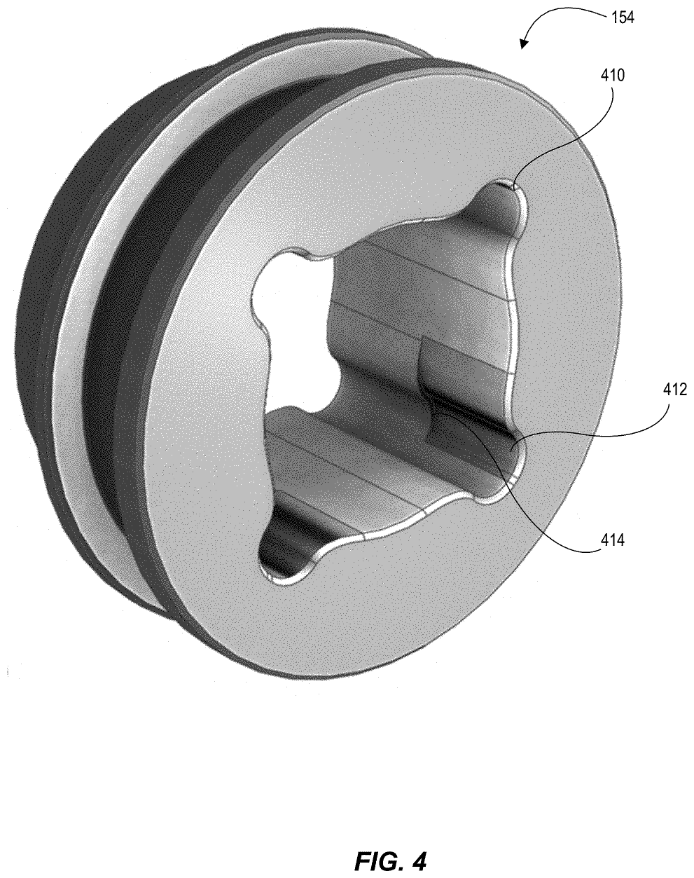

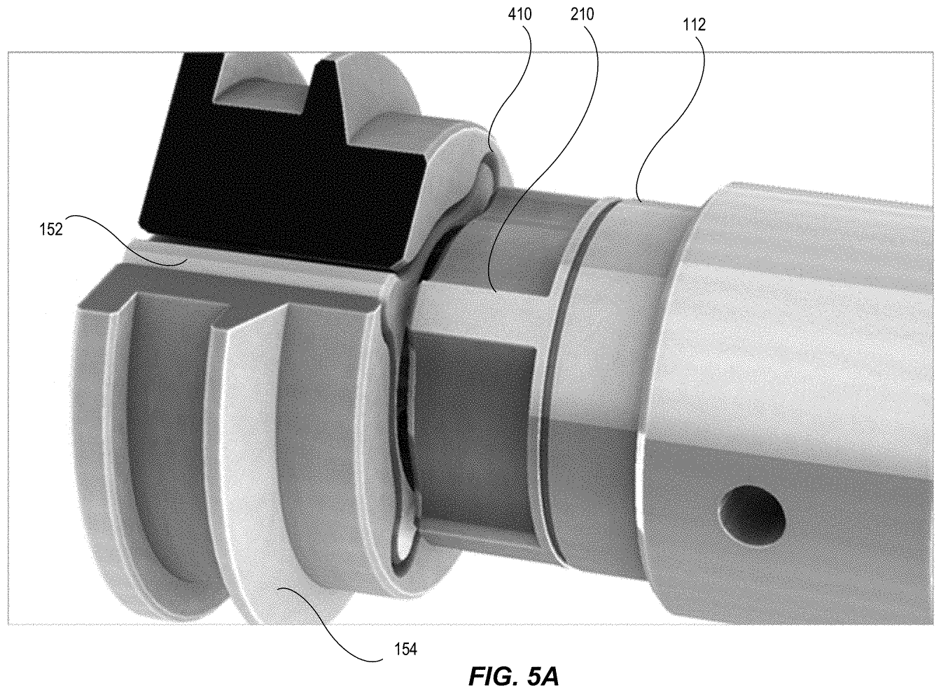

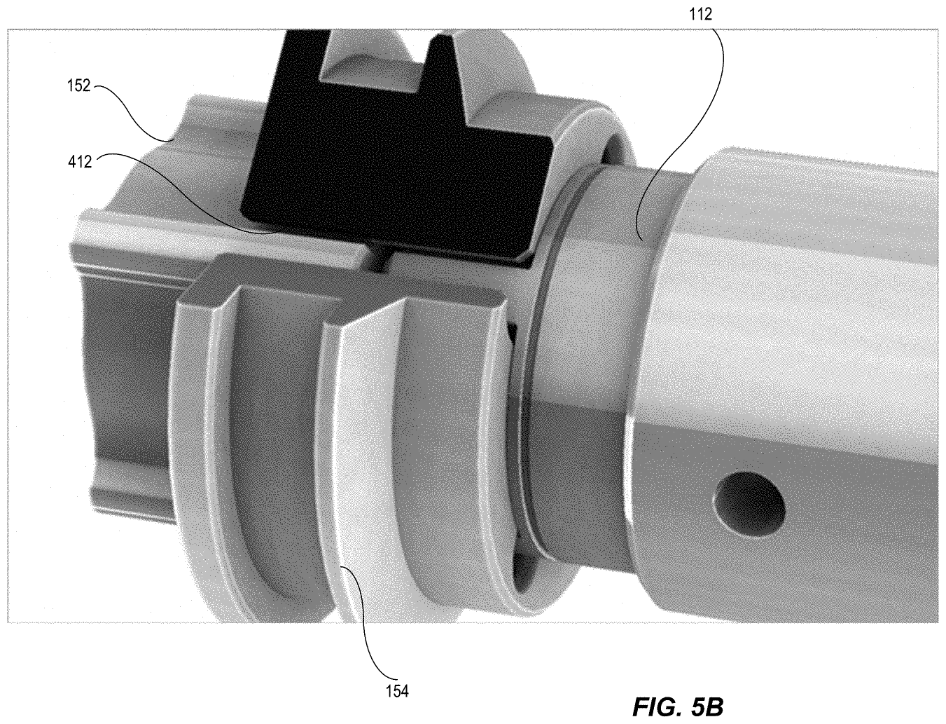

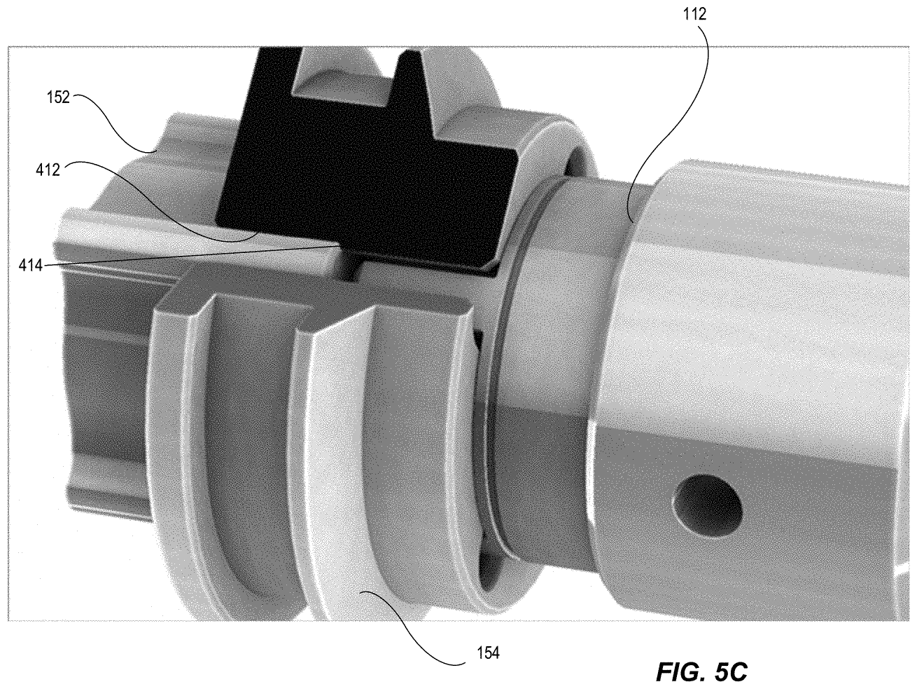

As shown, the line pulling drum 110 can be mounted on a first end 160 of the chassis 140 and be configured to receive the line. The line pulling drum 110 can have a driven element 112 (shown and discussed in more detail below, with reference to FIG. 2) to transfer power and/or torque from the motor 150 to the line pulling drum 110. In some examples, the driven element 112 can be mounted in a central position on the line pulling drum 110. The motor 150 can have a complementary driving element 152 (shown and discussed in more detail below, with reference to FIG. 3), shaped to interface with the driven element 112, and a coupling ring 154 (shown and discussed in more detail below, with reference to FIG. 4) to connect the driving element 152 to the driven element 112. The coupling ring 154 can be fitted around the driving element 152. In some examples, the coupling ring 154 can have a first uncoupled state in which the coupling ring 154 is not in contact with the driven element 112 and a second coupled state in which the coupling ring 154 is in contact with the driven element 112, coupling the motor 150 to the line pulling drum 110. An example of the driving element 152 and the coupling ring 154 are shown and described with reference to FIGS. 3 and 4, respectively, and in combination with the driven element 112 in FIG. 5A-C.

As shown in FIG. 2, the driven element 112 can have ridges, or shoulders 210, extending radially outward from the driven element 112. As shown in FIG. 3, the driving element 152 can have ridges, or shoulders 310 corresponding to the shoulders 210 of the driven element 112. The ridges and/or shoulders can have a variety of shapes so long as the ridges and/or shoulders comprise a portion of material raised and extended outward from the center of the driven element 112 and/or the driving element 152. For example, the shoulders can be any shape such as involute splines, a polygon of any number of sides, or smooth shapes such as an oval. The size of the shoulders can depend on the torque requirements and the spatial constraints of the containing assembly. In general, a smaller size can be better for manufacturing cost, while a larger size is better for torque transfer.

As shown in FIG. 4, the coupling ring 154 can comprise grooves 410 that correspond to the shoulders 210 and the shoulders 310. In such a manner, the coupling ring 154 can slide over the driven element 112 and the driving element 152. The grooves 410 can interact with the shoulders 210 and the shoulders 310 simultaneously so that the driven element 112 and the driving element 152 are attached. Therefore, when the line pulling drum 110 is under tension, the tensioning force can be transferred through the driven element 112 and the coupling ring 154 to the driving element 152 such that the driven element 112 and the driving element 152 are locked together or otherwise in mechanical communication with each other.

The grooves 410 can be any shape that allows the line pulling drum 110 (and therefore the driven element 112) to be in an orientation that is rotated some amount in the direction of torque while engaged and requires that the line pulling drum 110 be rotated some amount in the opposite direction of torque to disengage. The grooves 410, for example, can include a cutaway portion 412 that can be recessed and configured to contact the driving element 152 when the driving element 152 is engaged with the coupling ring 154. The cutaway portion 412 can have a ridge 414 that can contact the driving element 152 and prevent the coupling ring 154 from moving to an uncoupled position when the driving element 152 is applying force to the driven element 112 via the coupling ring 154 or when the driven element 112 is under tension and applying force to the driven element 112 via the coupling ring 154. In such a manner, the grooves 410 can create a locking effect by the cutaway portion 412. As will be appreciated, the ratio between the rotational displacement and linear displacement to disengage can affect the force required to disengage while the line pulling drum 110 is subjected to a given torque.

FIGS. 5A and 5B illustrate an example of the coupling ring 154 coupling with the driven element 112 and the driving element 152. As shown, the coupling ring 154 can have a first uncoupled position (FIG. 5A) and a second coupled position (FIG. 5B). The coupling ring 154 can be around the driving element 152 in the first position without contacting the driven element 112. Then, to transition to the second position, the coupling ring 154 can extend toward, or otherwise be moved toward, the driven element 112 until the coupling ring 154 is coupled with both the driven element 112 and the driving element 152. In some examples, the coupling ring 154 can freely transition between the first position and the second position. In other examples, the coupling ring 154 can remain in the second position, such as is shown in FIG. 5C, by the driving element 152 engaging with the cutaway portion 412 of the coupling ring 154. FIG. 5C illustrates the coupling ring 154, the driven element 112, and the driving element 152 connected when the driven element 112 is under tension. As explained previously and show in FIG. 5C, the coupling ring 154 can be configured to resist uncoupling when the driven element 112 (and thus the line pulling drum 110) is under tension because the cutaway portion 412 can prevent the coupling ring 154 from moving to the first position.

As explained in relation to FIG. 4, the cutaway portion 412 can create a ridge 414 that prevents the coupling ring 154 from sliding back over the driving element 152 and away from the driven element 112. In other words, the cutaway portion 412 can cause resistance to, or outright prevent, the coupling ring 154 from moving from the second position (coupled position) to the first position (uncoupled position). In some examples, the cutaway portion 412 can prevent the transition from the second position to the first position only when the driven element 112 (and thus the line pulling drum 110) is under tension (i.e., when the driving element 152 is engaged with the coupling ring 154). The shoulders 210 of the driven element 112 can transmit torque to the coupling ring 154 at the grooves 410, thus pushing the cutaway portion 412 against the shoulders 310 of the driving element 152. In such a manner, the driving element 152 and the driven element 112 can remain coupled (by the coupling ring 154) without the need for other pins, locks, screws, or fasteners. Additionally, the cutaway portion 412 can be configured such that the coupling ring 154 cannot be manually uncoupled from the driven element 112 by hand when the coupling ring 154 is under tension. This can help to prevent inadvertent decoupling of the driven element 112 from the driving element 152 which could lead to injury or damage to components. The cutaway portion 412 can also be configured such that the coupling ring 154 can be manually uncoupled from the driven element 112 by hand when the coupling ring 154 is not under tension.

In some examples the coupling ring 154 can comprise a single cutaway portion 412 and a single ridge 414 configured to contact the driving element 152. In other examples, the coupling ring 154 can comprise multiple cutaway portions 412. The cutaway portions 412 can be positioned proximate a groove 410 of the coupling ring and be configured to contact the driving element 152.

The driven element 112 and the driving element 152 can be designed in a number of ways. The driven element 112 and the driving element 152 can include plates, wheels, prongs, spokes, and the like. Both the driven element 112 and the driving element 152 can rotate around a central axis, and the driven element 112 and the driving element 152 can share a central axis. The driven element 112 can be permanently coupled to a “drive bar” which directly acts on the line pulling drum 110. Alternatively, or in addition, the driven element 112 can be directly coupled to the line pulling drum 110. The driving element 152 can be permanently or removably coupled to a gearbox and/or the motor 150. The driven element 112 and the driving element 152 can be any form of transmission component configured to transfer power and/or torque from the motor 150, from the driving element 152, to the driven element 112.

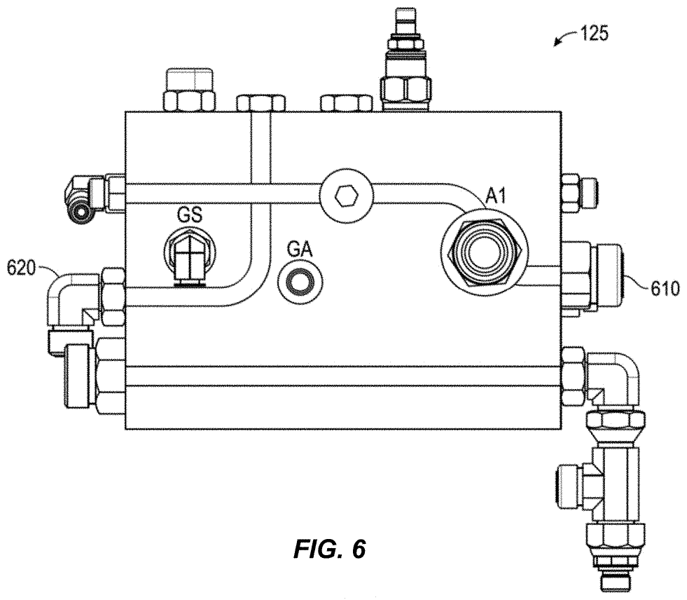

Referring back to FIG. 1A-1C, the hydraulic system 120 can also be mounted on the chassis 140. The hydraulic system 120 can include various lines and hoses to transfer hydraulic fluid throughout the line pulling system 100. The hydraulic system 120 can also include other components designed to control hydraulic fluid, such as pistons, valves, metering devices, and the like. In some examples, the hydraulic system 120 can include a manifold 125 as shown and described in relation to FIG. 6. The manifold 125 can be configured to fluidly communicate with two hydraulic lines 610, 620 from the hydraulic system 120 and to conduct heat between the two hydraulic lines 610, 620 as a heat exchanger. As will be appreciated, however, the manifold 125 is not limited simply to two hydraulic lines. The manifold 125 can be configured to conduct heat between any number of hydraulic lines in the hydraulic system 120. The manifold 125 is shown and described in greater detail with reference to FIG. 6.

As shown in FIG. 6, the manifold 125 can be configured to conduct thermal exchange between two or more hydraulic lines, such as a first hydraulic line 610 and a second hydraulic line 620. As such, the manifold 125 can be made from any material suitable to conduct heat between two (or more) fluids, such as aluminum, copper, titanium, carbon steel, stainless steel, cupronickel, monel, inconel, hastelloy, nickel, graphite, composite materials, or other suitable materials for the application. In some examples, the first hydraulic line 610 can correspond to a hydraulic circuit to drive the motor 150, and the second hydraulic line 620 can correspond to an auxiliary hydraulic circuit to power other components attached to the chassis 140. For instance, the first hydraulic line 610 that drives the line pulling drum 110 can be a closed loop system, meaning that the fluid is pushed from a pump to the motor 150 and then returns to the pump. In these systems, the flow rate from the pump often directly correlates to the speed of the line pulling drum 110. In closed loop systems, there is a certain amount of oil that is removed, sent to a holding tank and replaced for the purpose of cooling the loop.

The second hydraulic line 620 can be an open loop system, meaning that the fluid is pushed from the pump to actuators or valves and returns to the holding tank rather than returning to the pump. The pump then draws fresh fluid from the tank. Closed loop systems can be more susceptible to overheating because only a portion of the oil is removed for cooling. As will be appreciated, the first hydraulic line 610 driving the line pulling drum 110 can be hotter than the second hydraulic line 620 for the auxiliary circuit because the drum drive operation is continuous and can encounter larger forces than the auxiliary drive which is generally operated intermittently.

The manifold 125 of the present disclosure can be configured in a variety of designs to accommodate the two or more hydraulic lines and facilitate heat transfer between the two or more hydraulic lines. For example, the manifold 125 can be or include a heat exchanger such as a shell and tube, plate, plate and shell, adiabatic wheel, plate and fin, pillow plate, fluid, microchannel, helical coil, spiral, or any other suitable type of heat exchanger. Additionally, the manifold 125 can accommodate any number of hydraulic lines as desired. Furthermore, the hydraulic system 120 can include other thermal devices, such as heaters, coolers, condensers, evaporators, thermal expansion valves, and the like capable of exacting a temperature change to hydraulic fluid in the hydraulic system 120.

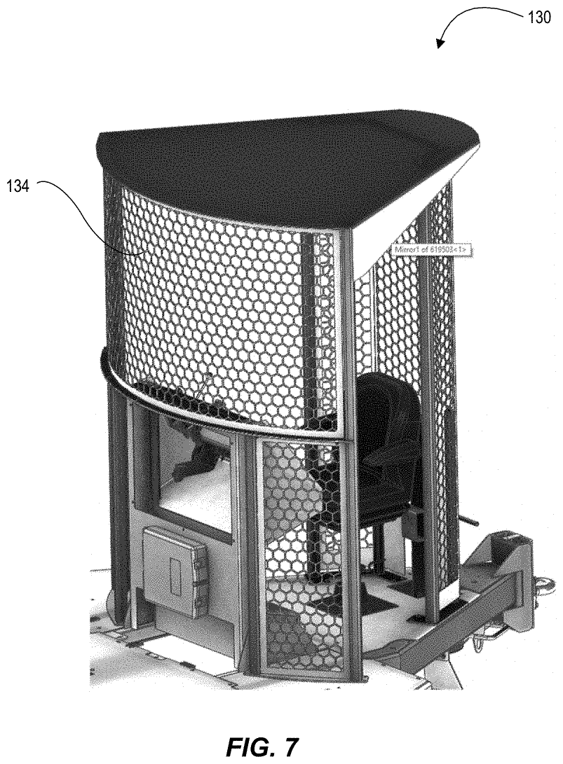

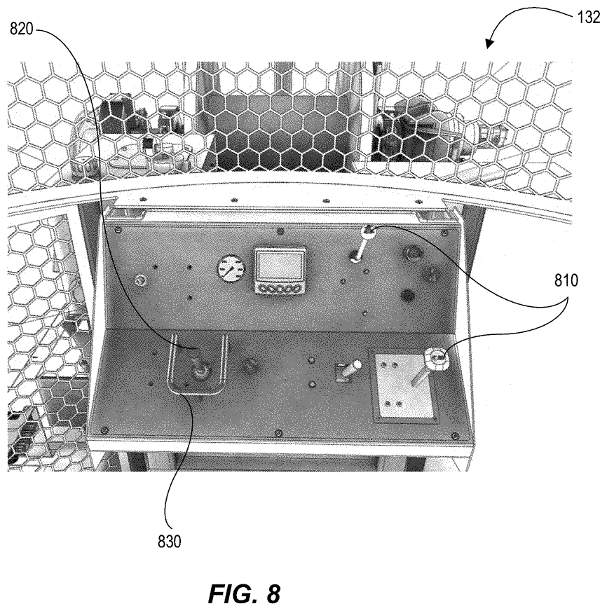

Referring again to FIG. 1A-1D, the operator station 130 can be mounted on the chassis 140. The operator station 130 can have a front safety screen 134 (shown and described in greater detail with respect to FIG. 7) between the operator station 130 and the line pulling drum 110. To further improve the safety of the operator station 130, the operator station can be mounted on the chassis 140 on a second end 170 opposite the first end 160 where the line pulling drum 110 is mounted. The operator station 130 can further comprise a control panel 132 (shown and described in greater detail with respect to FIG. 8) configured to communicate with the motor 150 and/or other components of the line pulling system 100.

As shown in FIG. 7, the front safety screen 134 can be curved to increase the protective surface area and to increase the deflection of forces or objects that happen to strike the front safety screen 134. Additionally, the curvature of the front safety screen 134 can be concentric or nearly concentric with the operator's point of view so that the line of sight of the operator can always be perpendicular (or close to perpendicular) to the safety screen. In such a manner, the operator can have a minimally obstructed view through the safety screen. The front safety screen 134 can further comprise a mesh (shown), window, grating, holes, or other suitable design such that the line pulling drum 110 (or other components attached to the chassis 140) are visible through the front safety screen 134. The visual designs (or apertures of the mesh, or grating, etc.) can be sufficiently small in size such that a loose line (or other projectile) is prevented from crossing into the operator station 130 through the front safety screen 134, while an operator is still able to see out of the front safety screen 134. For instance, if a metal grating is used, the spaces between the grating can be small enough to prevent a loose line or other debris from entering the operator station 130 while still remaining large enough to ensure the other components attached to the chassis 140 are visible. Alternatively, the front safety screen 134 can comprise a transparent material, rather than holes or other openings. For example, the front safety screen 134 can comprise a transparent window made from an acrylic or another transparent plastic material.

The front safety screen 134 may additionally have sufficient strength such that the front safety screen is able to withstand forces induced from striking (i.e., from a snapped and/or loose line, with a baseball bat, or crowbar), prying, tearing, cutting (i.e., with a saw), and/or wearing (i.e., with a Dremel or sander). In some examples, the front safety screen 134 can have sufficient strength to withstand forces from flying objects such as rope, conductor, swivels, and grips caused by a line breaking or some portion of a supporting structure breaking.

The front safety screen 134 can also have cutouts or apertures of a specific shape when the front safety screen 134 employs a mesh (as shown). For example, the front safety screen 134 can comprise hexagonal cutouts or apertures. The hexagonal cutouts can break up horizontal and vertical lines so that an operator can better distinguish objects outside the safety screen 134. It is understood that other shapes and patterns of cutouts can be used to create the front safety screen 134 and distinguish the lines of the front safety screen 134 from other lines outside of the front safety screen 134.

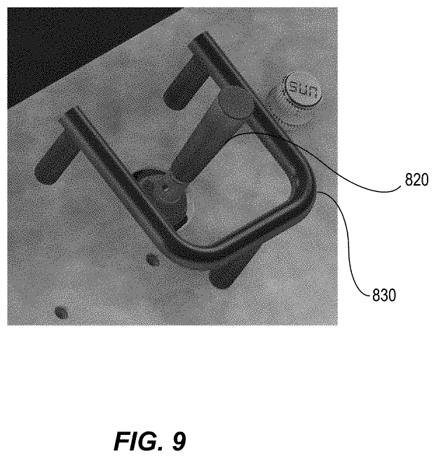

As shown in FIG. 8, the control panel 132 can have one or more controls 810 connected to one or more components of the line pulling system 100. The one or more controls 810 can also be in electrical communication with one another and/or the other components of the line pulling system 100. For example, the one or more controls 810 can include an on/off switch for the hydraulic system 120. In some examples, the one or more controls 810 can also be mechanically coupled to each other and/or the components of the line pulling system 100. As shown in FIG. 8, the one or more controls 810 can include a joystick 820 for controlling the line pulling drum 110 and/or level wind 148 (described below). The joystick 820 can be mechanically coupled (e.g., via cables, lines, pulleys, and the like) to the hydraulic system 120, line pulling drum 110, and the like. In order to increase user comfort, the control panel 132 can include a hand rest 830 disposed proximal to any of the one or more controls 810, as shown in FIG. 9.

As shown in FIG. 9, the hand rest 830 can be configured in a curved shape to partially or substantially surround any of the one or more controls 810, such as the joystick 820. The hand rest 830 can have one or more attachment points to fasten the hand rest 830 to the control panel 132. The attachment points can ensure that the hand rest 830 remains in place even after enduring a long life of use and wear-and-tear.

The hand rest 830 can also allow an operator to use the joystick 820 (or any other controls from the one or more controls 810) for longer periods of time and with greater precision. Having the hand rest 830 for control can enable an operator to stabilize their arm and utilize their grip, rather than arm and shoulder muscles, to actuate the controls. The hand rest 830 can also allow an operator to make more accurate movements.

Referring again to FIG. 1A-1D, the chassis 140 can be any form of frame, subframe, trailer, platform, and the like capable of supporting one or more components of the line pulling system 100. The chassis 140 can have a platform 142 to allow an operator to walk or move between the various components of the line pulling system 100. The chassis 140 can also be mounted on top of wheels 144 to allow the line pulling system 100 to be moveable. Any number of wheels can be used, such as two (e.g., if the chassis is a trailer), three, four, or more. In some examples, if the chassis 140 has only two wheels 144 (or multiple wheels on a single axle) or less and requires additional support, the chassis 140 can include a hitch 146 to attach the chassis 140 to a truck, car, trailer mount, jack stand, or other device that can provide stabilization to the chassis 140.

Additionally, the chassis 140 can include a level wind 148. As shown in FIG. 1A-1D, the level wind 148 can be attached to the chassis 140 proximal to the line pulling drum 110. The level wind 148 can also be attached to the hydraulic system 120 and/or in communication with the control panel 132. The level wind 148 can be configured to move laterally with respect to the line pulling drum 110 by a level wind hydraulic arm 149 to ensure that any lines being pulled will be evenly distributed around the line pulling drum 110. The level wind 148 can have a window through which a line can pass on its way to the line pulling drum 110. The window can ensure that the line is retained by the level wind 148, and the window can have rollers or other friction-reducing devices to ensure that the line can pass smoothly through the window. In some examples, the level wind 148 can also be powered by the hydraulic system 120.

The motor 150 can be any suitable motor to power one or more components of the line pulling system 100 (such as the line pulling drum 110), and the motor 150 can be powered by the hydraulic system 120. The motor 150 can be any motor suitable to transfer power from the hydraulic system 120 to the line pulling drum 110. The hydraulic system 120 can be powered by an engine, such as a diesel motor. Other types of engines can be used, such as gasoline, electric, hybrid, and the like. The engine can include various lines and connections to allow the engine to power the various components of the line pulling system 100, including the hydraulic system 120. The engine can also be connected to a fuel tank, or other energy storage device (e.g., a battery), to provide power to the engine.

The motor 150 can be mounted on the chassis 140 proximal to the line pulling drum 110 and/or the hydraulic system 120, such as on the platform 142. The engine, powering the hydraulic system 120, can be external to the chassis 140, such as a portable generator. In some examples, if the engine is external to the chassis 140, the chassis 140 can have mounting points to store the engine when not in use.

While several possible examples are disclosed above, examples of the present disclosure are not so limited. For instance, while the system is discussed above with reference to suspending power or communications lines, the system could also be used in many other industries such as transportation (e.g., towing, cables cars, street cars, and trains); rope for climbing, rigging, and boundaries; and virtually any other types of lines that need to be strung and/or suspended. In addition, while various features are disclosed, other designs could be used. Such changes are intended to be embraced within the scope of this disclosure. The presently disclosed examples, therefore, are considered in all respects to be illustrative and not restrictive.

What is claimed is:

1. A line pulling system comprising:
a chassis configured to support a line pulling drum, the line pulling drum being configured to receive a line;
a motor configured to rotate the line pulling drum in a first direction to cause the line to wind around the line pulling drum and in a second direction to facilitate removal of the line from the line pulling drum;
a driven element coupled to the line pulling drum;
a driving element coupled to the motor; and
a coupling ring configured to transition between an engaged position and a disengaged position,
wherein, when in the engaged position, the coupling ring is configured to couple the driving element to the driven element to cause a torque applied by the motor to be transferred to the line pulling drum, and
wherein, when in the disengaged position, the coupling ring is configured to uncouple the driving element from the driven element.

2. The line pulling system of claim 1, wherein the driven element and the driving element each comprise a plurality of shoulders, and
wherein the coupling ring comprises a plurality of grooves configured to receive the plurality of shoulders such that the coupling ring is configured to slide along the driven element and the driving element between the engaged position and the disengaged position.

3. The line pulling system of claim 2, wherein the driven element comprises four shoulders, the driving element comprises four shoulders, and the coupling ring comprises four grooves.

4. The line pulling system of claim 2, wherein the coupling ring further comprises a cutaway portion, the cutaway portion forming a ridge configured to contact the driving element when the coupling ring is in the engaged position to prevent the coupling ring from transitioning to the disengaged position.

5. The line pulling system of claim 4, further comprising a plurality of cutaway portions, each cutaway portion of the plurality of cutaway portions forming a ridge configured to contact the driving element when the coupling ring is in the engaged position and being positioned proximate each groove of the plurality of grooves.

6. The line pulling system of claim 4, wherein the ridge is configured to contact the driving element when a tension is applied to the driven element.

7. The line pulling system of claim 1 further comprising a hydraulic system, the hydraulic system comprising a manifold configured to facilitate heat transfer between a first hydraulic line and a second hydraulic line.

8. The line pulling system of claim 7, wherein the manifold comprises a heat exchanger configured to facilitate heat transfer between the first hydraulic line and the second hydraulic line.

9. The line pulling system of claim 7, wherein the first hydraulic line is configured to drive the line pulling drum and the second hydraulic line is configured to drive an auxiliary component.

10. The line pulling system of claim 9, wherein the first hydraulic line comprises a closed loop system and the second hydraulic line comprises an open loop system.

11. The line pulling system of claim 1 further comprising an operator station, the operator station comprising:
a safety screen positioned between the line pulling drum and the operator station; and
a control panel configured to communicate with at least the motor.

12. The line pulling system of claim 11, wherein the safety screen is curved to deflect objects that strike the safety screen.

13. The line pulling system of claim 11, wherein the safety screen comprises a mesh.

14. The line pulling system of claim 13, wherein the mesh comprises apertures having a hexagonal shape.

15. The line pulling system of claim 11, wherein the control panel comprises:
a joystick configured to facilitate control of the line pulling drum; and
a hand rest configured to support a hand of an operator of the line pulling system.

16. The line pulling system of claim 1, wherein the chassis comprises a trailer having a plurality of wheels and a trailer hitch.

17. The line pulling system of claim 1, wherein the chassis further comprises a level wind configured to move laterally with respect to the line pulling drum to ensure a line wound around the line pulling drum is distributed evenly.

18. A line pulling system comprising:
a chassis comprising a plurality of wheels and a hitch;
an operator station mounted on the chassis and comprising a control panel and a safety screen;
a line pulling drum mounted on the chassis and configured to receive a line;
a motor mounted on the chassis and configured to rotate the line pulling drum in a first direction to cause the line to wind around the line pulling drum and in a second direction to facilitate removal of the line from the line pulling drum;
a driven element coupled to the line pulling drum;
a driving element coupled to the motor; and
a coupling ring configured to transition between an engaged position and a disengaged position,
wherein, when in the engaged position, the coupling ring is configured to couple the driving element to the driven element to cause a torque applied by the motor to be transferred to the line pulling drum, and
wherein, when in the disengaged position, the coupling ring is configured to uncouple the driving element from the driven element.

19. The line pulling system of claim 18, wherein the driven element and the driving element each comprise a plurality of shoulders, and
wherein the coupling ring comprises a plurality of grooves configured to receive the plurality of shoulders such that the coupling ring is configured to slide along the driven element and the driving element between the engaged position and the disengaged position.

20. The line pulling system of claim 19, wherein the coupling ring further comprises a cutaway portion, the cutaway portion forming a ridge configured to contact the driving element when the coupling ring is in the engaged position to prevent the coupling ring from transitioning to the disengaged position.
